(19) United States
(12) Patent Application Publication
(10) Pub. No.: US 2007/0262776 A1
(43) Pub. Date: Nov. 15, 2007

(54) Magnetic Resonance Imaging Magnet Assembly System with Improved Homogeneity

(76) Inventors: Labros S. Petropoulos, Auburn, OH (US); Michael Steckner, Richmond Heights, OH (US)

Correspondence Address: BUCKINGHAM, DOOLITTLE & BURROUGHS, LLP, 3800 EMBASSY PARKWAY, SUITE 300, AKRON, OH, 44333-8332, US

(21) Appl. No.: 11/382,554

(22) Filed: May 10, 2006

(51) Int. Cl. G01V 3/00

(52) U.S. Cl. 324/318; 324/320

(57) ABSTRACT

Described herein is a magnet system for use in imaging a volume that includes a main magnet and at least one magnet coil assembly positioned between the main magnet and the imaging volume. A gradient coil assembly including an inner primary gradient coil alone or with the addition of an outer secondary gradient coil may also exist between the main magnet and imaging volume. The magnet coil assembly may then be positioned between the inner primary gradient coil and the imaging volume, between the inner primary gradient coil and outer secondary gradient coil, or in both positions. Also described herein is an MRI system incorporating the magnet system with additional magnet coil assemblies, and the process for improving the homogeneity of a magnet system using the additional magnet coil assemblies.

### TECHNICAL FIELD

The invention relates generally to a magnet system for a magnetic resonance imaging (MRI) system. More specifically, this invention relates to a magnet system with booster coils for improved field homogeneity for a magnet system.

### BACKGROUND OF THE INVENTION

Magnetic resonance imaging (MRI) is a medical diagnostic imaging technique used to diagnose many types of injuries and medical conditions. An MRI system includes a main magnet for generating a main magnetic field through an examination region. The main magnet is arranged such that its geometry defines the examination region. The main magnetic field causes the magnetic moments of a small majority of the various nuclei within the body to be aligned in a parallel or anti-parallel arrangement. The aligned magnetic moments rotate around the equilibrium axis with a frequency that is characteristic for the nuclei to be imaged. An external radiofrequency (RF) field applied by other hardware within the MRI system perturbs the magnetization from its equilibrium state. Upon termination of the application of the RF pulse, the magnetization relaxes to its initial state. During relaxation the time varying magnetic moment induces a detectable time varying voltage in the receive coil. The time varying voltage can be detected by the receive mode of the transmit coil itself, or by an independent receive only coil.

MRI systems are made of many hardware components that work in conjunction with specialized software to produce the final images. FIG. 1 illustrates an MRI system of Prior Art, with the front cover removed so the main hardware components can be seen. Magnet 12 is the main hardware component of MRI system 10 and is responsible for producing the uniform main magnetic field, B₀. Magnets used in MRI systems are very large and can have a horizontal or a vertical magnetic field.

Three types of magnets are currently used in MRI systems: resistive magnets, permanent magnets, and superconducting magnets. High field magnets are typically designed with superconductive wire technology, passing electrical current through coils or windings of superconducting material formed around a non-ferromagnetic former to create the magnetic field. Cryogenically cooling a superconducting magnet using helium, liquid nitrogen, or other conductive cooling methods causes the electrical resistance of the coils or windings of wire in the superconducting magnet to drop essentially to zero, allowing large amounts of electrical current to travel through the magnet for long periods of time with minimal loss of energy as heat. Commonly, a cold head is attached to a helium dewar in order to reduce the helium boil-off level to a minimum.

Within the volume defined by main magnet 12 is at least one gradient coil 14. Gradient coil 14 produces substantially linear spatially varying magnetic fields within the main magnetic field that are coincidental with the direction of the main magnetic field but vary along the three orthogonal directions (x, y, z) of the Cartesian coordinate system. Initially, gradient coils included only single primary gradient coil unit 18, however, the presence of spurious and spatially dependent eddy currents on the magnet's dewar structure necessitated the need to shield the gradient magnetic field at the magnet's vicinity. Secondary shielding gradient coil 20 was added to the primary gradient coil's structure with a required minimum gap between the primary and secondary gradient coil structures. The larger the gap the more efficient the gradient coil is, however limitations on the minimum allowable size for the patient bore as well as the maximum allowable size of the inner magnet bore limits the radial separation between the primary and secondary coil units.

Other hardware within the MRI system includes a patient couch that supports the imaging volume to be examined within the examination region, Radiofrequency (RF) transmit coil (not shown) produces a perturbing RF pulse across the examination region. RF receive coil 16, shown in FIG. 1, exists to receive magnetic resonance signals from the precessing magnetic moment within the imaging volume. An image processor (not shown) then reconstructs an image representation from the received and processed magnetic resonance signals for display on a human readable display.

An important characteristic of a magnet for use in an MRI system is the homogeneity of the magnet. Homogeneity is the measure of uniformity of the magnetic field produced by the main magnet. The geometric shape, main magnet manufacturing tolerances and environmental siting factors contribute to the inhomogeneity and non-uniformity of the magnetic field.

Homogeneity of a magnetic field in a specified volume is calculated by determining the difference between the minimum and maximum values of the magnetic field. This number is commonly in the micro-Tesla range, and can be converted into parts per million (PPM) by dividing by the mean magnetic field found at the center of the magnet and multiplying the result by 10⁶. The lower the parts per million (PPM) value of the static magnetic field inhomogeneity within the desired imaging volume, the better the quality of the magnetic field.

The predetermined area of substantial magnetic field homogeneity is known in the art as the diameter spherical volume (DSV). It is possible to design a very large magnet structure with ideal homogeneity in the DSV, but as the size of the magnet becomes smaller, the magnetic field homogeneity is reduced, or the specification DSV must be reduced. Also, when the gradient coils of the system are pulsed, a time changing magnetic flux results. Eddy currents are produced, and generate magnetic fields that further reduce the homogeneity of the system magnet.

It is desired within the art to reduce the size of a magnet design while maintaining current magnetic field homogeneity over the largest possible region, or to maintain the size of a magnet design while improving current field homogeneity for a given DSV. Prior Art controls the homogeneity of the main magnetic field by both passive and active shimming techniques. Passive shimming includes arranging shim steel within the inside diameter of the magnet coil assembly to minimize static magnetic field inhomogeneities based upon measurements taken in the environment surrounding the magnet. Active shimming uses multiple orthogonal shim coils and gradient coil offsets. An electrical current is applied to the shim coils and gradient coil offsets in order to cancel inhomogeneities in the main magnetic field.

The art of designing and engineering superconductive magnets with acceptable homogeneity can be seen in the patents of Laskaris et. al., namely U.S. Pat. No. 6,215,383, U.S. Pat. No. 6,783,059, and U.S. Pat. No. 6,504,461. The coil bundles discussed in each patent are made from superconductive material inside a predetermined dewar vacuum chamber. It is characteristic that no coil bundle in the proposed designs are on a separate electrical or mechanical structure. It is also characteristic of the aforementioned patents that the magnet dewar has a considerably higher radius than the projected radii of the gradient coil and RF body coil assembly.

Asymmetric magnets have been tried, as shown in Crozier et. al., U.S. Pat. No. 6,140,900 and Crozier et. al., U.S. Pat. No. 6,700,468. Magnet former modifications have also been attempted, see Kruip et. al., U.S. Pat. No. 6,937,126 and Huang et. al., U.S. Pat. No. 6,504,461. Other theories have also been examined, as explained in Crozier et. al., U.S. Pat. No. 5,818,319.

In these past attempts to maximize homogeneity the corrections to inhomogeneity resulted from the mechanical tolerances of placing superconductive wire bundles inside the main dewar. For horizontal superconductive magnets, it is characteristic of the past attempts to increase the magnet's imaging volume and homogeneity while reducing its overall size and length with the additional coil bundles that are made from superconductive material and enclosed inside the dewar vacuum chamber. None of the coil bundles are on a separate mechanical or electrical structure and are located a considerable distance farther from the gradient coil and RF coil assemblies.

Many magnet designs have been attempted to achieve maximum homogeneity, while also taking into account other requirements of the MRI system such as field of view (FOV) of the desired imaging volume, bore size, magnet size, etc. In order to maintain the field homogeneity inside the desired imaging volume while reducing the overall size and length of the magnet, additional superconductive coil elements are necessarily placed inside the existing magnet dewar. However, limitations on the current density requirements as well as the maximum local critically magnetic field for the chosen superconductive wire prohibits the placement of unlimited coil elements inside the dewar. Thus, designs that are shorter in length and smaller in size may reduce the field of view in the head-foot (in-out) direction in order to reduce the current densities in the coil bundles to below the predetermined acceptable level. One further factor limiting the design of the superconducting magnet is finite current capacity of the superconducting wire.

Another attempt to improve homogeneity of the magnetic field was made by increasing the diameter at the center of the magnet barrel, effectively creating a bulge in the middle of the magnet barrel, as explained in “A Novel Concept for Gradient Coil and Magnet Integration” by Heid, et, al as published at the 13^{th} Meeting of ISMRM in Miami, Fla. in 2005. The gradient coil was then split in half along the vertical axis to incorporate the space created by the bulge at the center of the magnet. This method was successful in decreasing the size of the magnet while maintaining the levels of inhomogeneity. However, this method also requires a complete redesign of the entire MRI system, making it impracticable for use with existing designs.

Therefore, as shown in the Prior Art, there is an existing need for a magnet system with improved homogeneity.

### SUMMARY OF THE INVENTION

The above described need is met by adding magnet coil booster packs in unused space within the gradient coils and/or within the unused space between the gradient coils and RF coils for the purpose of increasing the homogeneity of the superconducting main magnet of the magnetic resonance imaging (MRI) system.

It is an object of this invention to describe a magnet system that has a homogenous magnetic field over the desired field of view of clinical images for use in a magnetic resonance imaging system (MRI).

It is another object of this invention to describe an MRI magnet system having coil booster packs or coil bundles positioned in previously unused space within the gradient coils, between the gradient coils and RF coil, or at the ends of the bore to maintain the homogeneity of the previous magnet system while reducing the size of the mechanical structure of the magnet.

It is a further object of this invention to describe an MRI magnet system utilizing coil booster packs that maintain the size of the magnet system, while improving the homogeneity of the magnetic field.

It is yet another object of this invention to describe an MRI magnet system utilizing coil booster packs to create a smaller magnet, thus reducing the cost of manufacturing the magnet and easing installation of the magnet.

It is yet a further object of this invention to describe an MRI magnet system utilizing the above described coil booster packs for a vertical or horizontal magnetic field system of any field strength and conceivable application.

These and other objects of the present invention will become more readily apparent from a reading of the following detailed description taken in conjunction with the accompanying drawings wherein like reference numerals indicate similar parts, and with further reference to the appended claims.

### BRIEF DESCRIPTION OF THE DRAWINGS

The invention may take physical form in certain parts and arrangements of parts, numerous embodiments of which will be described in detail in the specification and illustrated in the accompanying drawings which form a part hereof, and wherein:

FIG. 1 is a front elevational cross-sectional view of an MRI system (not to scale) indicative of Prior Art systems.

FIG. 2 is a front elevational cross-sectional view of an MRI system (not to scale) of one embodiment of this invention, with the addition of coil booster packs within the gradient coil assembly;

FIG. 3 is a side cross-sectional view of FIG. 2 taken on plane 3-3.

FIG. 4 is a front elevational cross-sectional view of an MRI system (not to scale) of another embodiment of this invention, with the addition of coil booster packs between the gradient coil assembly and the RF coil or imaging volume;

FIG. 5 is a front elevational cross-sectional view of an MRI system (not to scale) of a further embodiment of this invention, with the addition of coil booster packs both within the gradient coil assembly and between the gradient coil assembly and the RF coil or imaging volume;

FIG. 6 is a perspective view of a horizontal field MRI system (not to scale) showing the Prior Art, which is also Magnet Design #1 (magnet without coil booster packs);

FIG. 7 is a perspective view of a horizontal field MRI system (not to scale) showing Magnet Design #2 (magnet with a coil booster pack within the gradient assembly);

FIG. 8 is a contour plot showing the homogeneity of the Prior Art indicative Magnet Design #1 (magnet without coil booster packs); and

FIG. 9 is a contour plot showing the homogeneity of Magnet Design #2 (magnet with a coil booster pack within the gradient assembly).

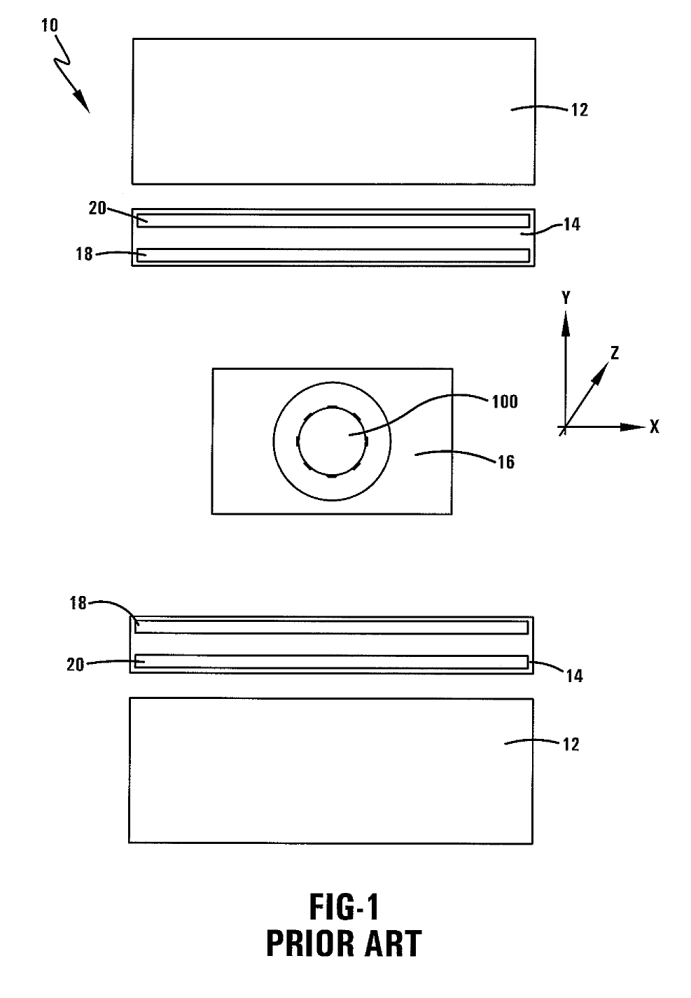

### DETAILED DESCRIPTION OF THE INVENTION

Referring now to the drawings wherein the showings are for purposes of illustrating numerous embodiments of the invention only and not for purposes of limiting the same, the figures illustrate the novel idea of adding coil booster packs in unused space within the gradient coils and/or within the unused space between the gradient coils and RF coils for the purpose of increasing the homogeneity of the superconducting main magnet of the magnetic resonance imaging (MRI) system.

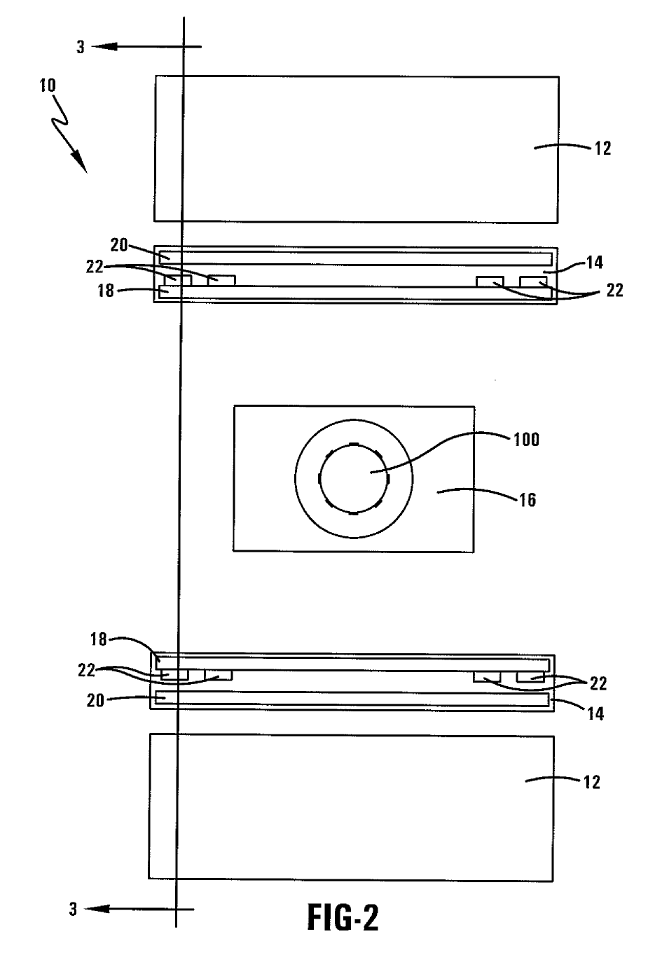

This invention is applicable to any superconducting magnet system, including horizontal field magnets, vertical field magnets, and any other type of magnet system. This invention will commonly be used with a superconducting magnet system used in an MRI system, including but not limited to a horizontal field closed system, a vertical field open system, or any other type of magnet of any strength. In the center of system 10 in FIG. 2 is an imaging volume of interest 100. Non-limiting examples of an imaging volume of interest is a patient, an animal, a test device, or a chemical solution filled bottle with similar properties to a particular part of the human anatomy, also called a phantom.

The MRI system in FIG. 2 includes main magnet 12. The main magnet can be any magnet including, but not limited to, a magnet with a horizontal or vertical magnetic field of any field strength, or a magnet of any shape, radius, size, or length producing any strength field in an arbitrary direction. Gradient coil assembly 14 is within the volume created by the mechanical structure of main superconducting magnet 12. Gradient coil assembly 14 can include, but is not limited to only primary gradient coil 18 or primary gradient coil 18 and secondary gradient coil 20. Commonly, at least one RF receive coil 16 is between gradient coil assembly 14 and imaging volume 100.

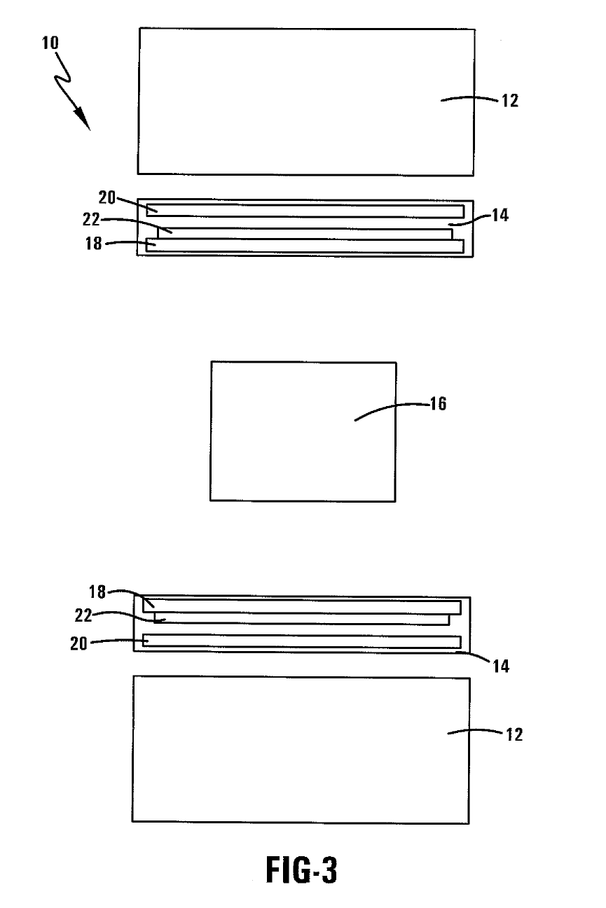

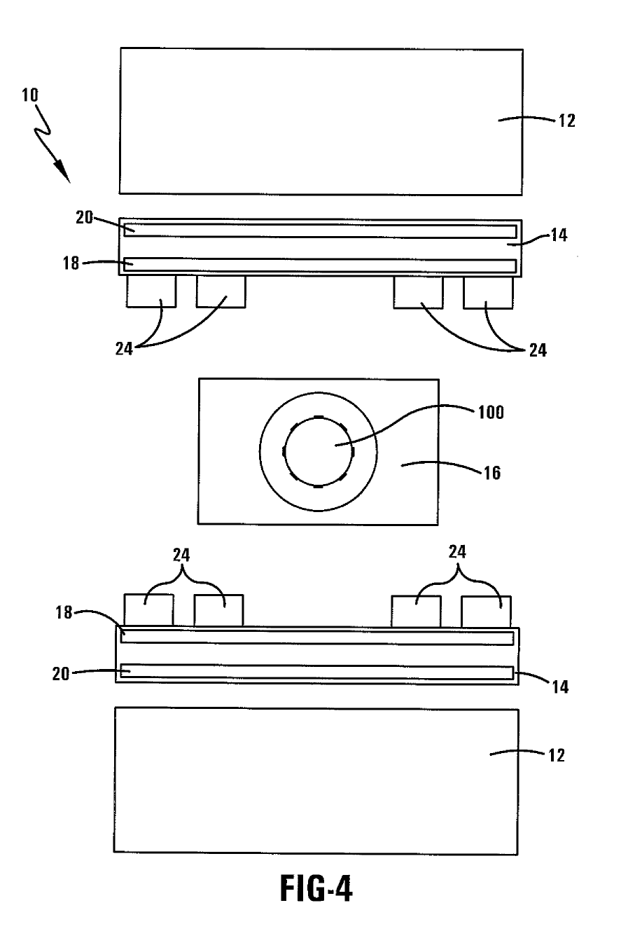

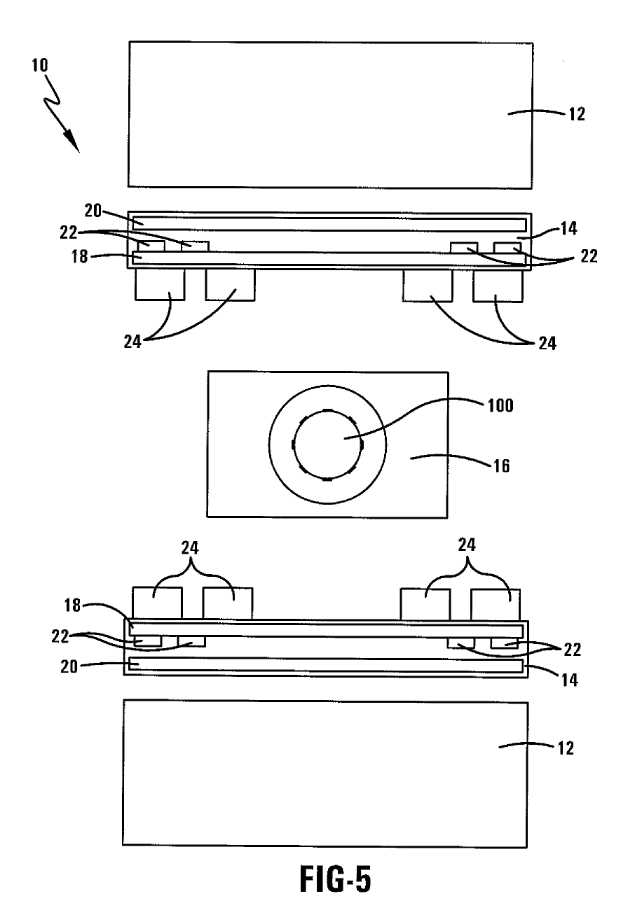

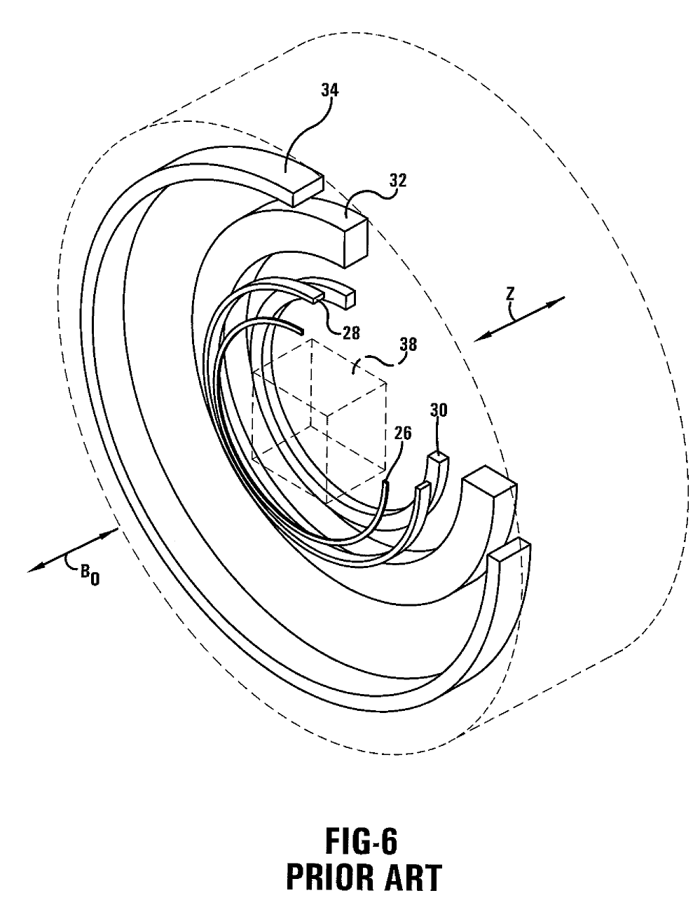

Typically, unused space or voids exist within the mechanical structure of gradient coil 14. Additional magnet coil booster packs 22 are added to this previously unused space, between primary gradient coil 18 and secondary gradient coil 20. The magnet coil booster packs effectively increase the homogeneity of main magnet 12. FIG. 3 shows a side view of FIG. 2 taken along plane 3-3. FIG. 4 illustrates additional booster packs 24 added to the previously unused space between gradient coil assembly 14 and imaging volume 100 or RF coil 16. Further, FIG. 5 shows additional coil booster packs 22 and 24 placed between primary gradient coil 18 and secondary gradient coil 20, as well as between gradient coil assembly 14 and imaging volume 100 or RF coil 16. In summary, additional coil booster packs 22 and 24 can be added within gradient coil assembly 14, meaning between primary gradient coil 18 and secondary gradient coil 20 only, between gradient coil assembly 14 and imaging volume 100 or RF coil 16 only, or both within gradient coil assembly 14, and between gradient coil assembly 14 and imaging volume 100 or RF coil 16 as necessary for the optimal homogeneity of the magnet design.

The coil booster packs used as add-on components to already designed systems can take on a number of shapes, as they can be shaped as a cube or rectangular prism on a vertical field system, or circular rings in a horizontal field system. The size of these add-on coil booster packs will vary depending on the desired imaging volume required, but must be sized to fit within the open space within the gradient coil assembly or between the gradient coil assembly and the imaging volume or the RF coil. Thus, the maximum size allowable for the coil booster packs within the gradient coil assembly is the amount of open space remaining in the gradient coil design. The maximum size allowable for the coil booster packs between the gradient coil assembly and the RF coil or imaging volume is the amount of open space remaining in the patient bore below the gradient coil assembly that is not occupied by the imaging volume.

The exact homogeneity enhancing position of the coil booster packs can also vary to achieve the optimal homogeneity of the magnet system, however the location of the booster packs of this invention is characteristically not within the main magnet structure, and closer to the imaging volume, differing from the shimming methods of Prior Art. Positioning of the coil booster packs within the gradient coil assembly or between the gradient coil assembly and the RF coil or imaging volume allows for the coil booster pack bundles to be closer to the imaging volume than the main magnet can be. The coil booster packs are commonly significantly smaller than the main magnet and can extend down into the volume within the bore that is unused in current magnet designs, still leaving enough open volume within the bore for the imaging volume. Positioning the coil booster pack bundles closer to the imaging volume allows a reduction in the amount of current necessary to extend the homogeneity volume along the head-foot (H-F) direction. Preferably, the coil booster packs will be positioned to simulate a closing of the bore to create the ideal spherical shape that leads to optimum homogeneity. Multiple booster packs may be positioned, or stacked, on the same longitudinal axis, and will accomplish a similar affect to positioning one block of the same thickness as the multiple stacked booster packs. After the initial general position of the coil booster packs is decided, a minimization algorithm commonly known in the art can isolate the most preferable homogeneity enhancing location for the packs with respect to the predetermined characteristics desired from the magnet, such as size, field of view, and magnetic field strength.

It should be noted that while the coil booster packs can be used to increase homogeneity, the direction of the coil booster's magnetic field can also be reversed to limit the field of view to minimize imaging problems such as the appearance of aliasing and cusp artifacts. It should also be noted that it is not essential that a new magnet system or MRI system be designed to utilize the coil booster packs. It is possible to integrate the coil booster packs with an already existing magnet design or an already existing MRI system to increase the homogeneity of the magnet from its current homogeneity.

The additional coil booster packs will typically be wound filament of wire that are made of a high temperature superconducting material or a conventional superconducting material. When the booster packs require cryogenic cooling, they may be cooled with an ancillary dewar system, as opposed to the shimming methods of Prior Art wherein the shims were enclosed in the main dewar system. When the additional coil booster packs are made of a high temperature superconducting material, the packs can be encapsulated in their own individual annular ring dewar system for nitrogen cooling of the Hi-Tc superconductive material. When the booster pack bundles are made of a conventional superconducting material, the packs can be surrounded in their own annular ring dewar system for helium cooling of the conventional superconducting material. Other embodiments of this invention allow for K-4 refrigeration and conduction cooling, or any other appropriate cooling system used with any of the materials appropriate for constructing the booster packs. If the demand on expansion in the H-F axis allows, regular resistive wire can be used to create the coil booster packs. When resistive wire is used water cooling of the packs would be appropriate. No low temperature cryogenic cooling of the resistive wire booster packs is needed, however water cooling mechanisms to extract the heat from the coil bundles can also be used, with no additional dewar system being needed.

Though the coil booster packs are placed exterior to the main magnet structure and dewar system, differing from the shimming techniques of Prior Art, the coil booster packs are still an integral part of the magnet design. The contribution of the additional coil booster packs to shielding, higher order moments for the internal and external magnetic fields, and calculations for the 5-Gauss line of the system should be evaluated simultaneously with the main superconducting magnet. Coil booster pack bundles made of Hi-Tc superconducting material must have current densities less than 150 A/mm² but the restriction of such current density requirements may not be necessary in the future as the science of making Hi-Tc superconductive wire with very high current density requirements is aggressively progressing. Coil booster pack bundles made of conventional superconducting material can have a slightly higher current density depending on the type of wire and its construction, however care must be taken not to exceed the critical point of the superconducting bundles.

This invention will most commonly be integrated with the magnet system of an MRI system, which would include, but not be limited to a main magnet for generating the magnetic field throughout the imaging or examination region. The geometry of the magnet would define the examination region. The MRI system would also include a gradient coil assembly, used to generate the magnetic gradient across the main magnetic field. The at least one magnet coil assembly would be positioned in at least one location either within the gradient coil assembly, between the secondary and primary gradient coils, between the gradient coil assembly and the imaging volume, or between the gradient coil assembly and the main magnet. A patient table, or couch, commonly exists to support the patient during the imaging procedure and house the other necessary electronics and mechanics. A receiver coil is responsible for receiving the MR signals from the resonating dipoles within the examination region. An image processor consisting of a computer console and specialized software is used to reconstruct the image representation from the received MR signals for display on a readable display which the technologist or doctor later reads.

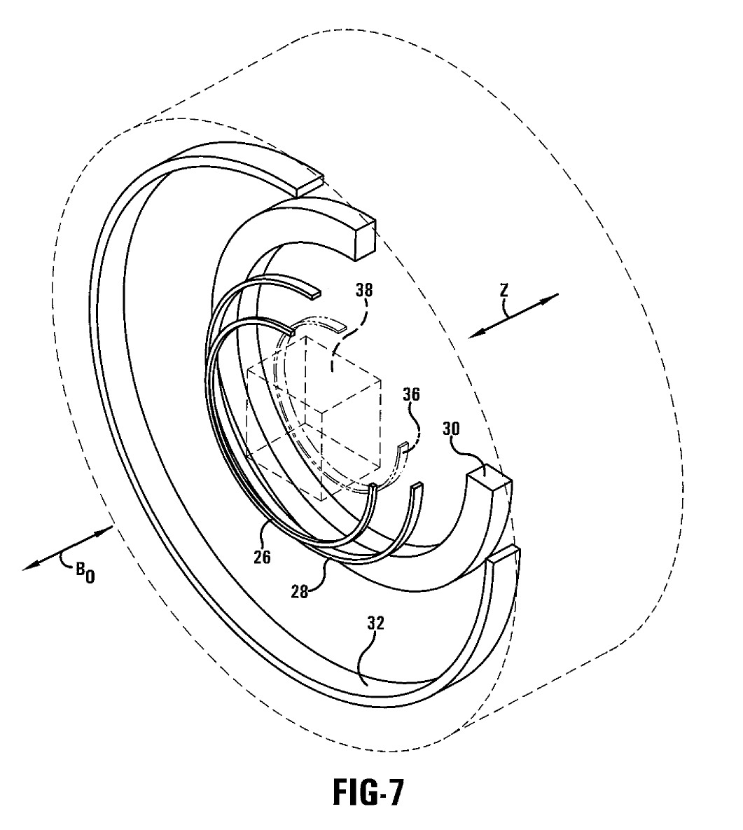

A comparison of one embodiment of this invention with a Prior Art magnet system follows. For this theoretical experiment, a horizontal field MRI system utilizing Prior Art is shown in FIG. 6 as Magnet Design #1 and contains no coil booster packs. A horizontal field MRI system incorporating the invention is shown in FIG. 7 as Magnet Design #2 and contains coil booster pack 36 positioned within the gradient coil, between the primary gradient coil and the secondary gradient coil.

Both the Prior Art shown in Magnet Design #1 and the embodiment of the invention of Magnet Design #2 are theoretically designed superconducting magnets with a horizontal magnetic field, as indicated by B₀ in FIG. 6 and FIG. 7. As with the typical horizontal magnet, they appear to be tubular, and are comprised of a number of coil windings 26, 28, 30, 32 and 34 (FIG. 6) and 26, 28, 30, and 32 (FIG. 7) along the length of the tube. The coil booster pack appears in Magnet Design #2 as Winding 3 36 (FIG. 7). The coil booster pack is located within the gradient coil assembly.

The field constraints for both magnets used in this example are assigned by using characteristics that are commonly desired in a typical application. Both have a magnetic field strength of 1.5 Tesla, with a field of view (FOV) 38 of 45 cm in the transverse plane and 35 cm along the head-to-foot axis. The electrical lengths of magnet 12 in both FIG. 6 and FIG. 7 are constrained to not exceed 100 cm along the head-to-foot axis z and are constrained to a radius not exceeding 1.45 m. The common current density per main coil winding 26, 28, 30, 32 and 34 (FIG. 6) and 26, 28, 30, and 32 (FIG. 7) is constrained to be 134.4 Amps/mm² for both magnet systems 10

Coil winding 26, 28, 30, 32 and 34 (FIG. 6) and 26, 28, 30, and 32 (FIG. 7) positions of the main magnet for Magnet Design #1, indicating Prior Art (FIG. 6) and Magnet Design #2 (FIG. 7) of the current invention are determined by initially choosing an appropriate general position for each coil, as is known from Prior Art. The initial positions are then processed using a minimization algorithm that picks the optimum coordinates of each coil winding 26, 28, 30, 32 and 34 (FIG. 6) and 26, 28, 30, and 32 (FIG. 7) based upon the demands of the field strength and homogeneity of the desired magnet using the predetermined field constraints, like those described for the Prior Art shown in Magnet Design #1 and Magnet Design #2 showing the current invention, in the above paragraph.

Winding #3 36 in Magnet Design #2 (FIG. 7) is positioned to be the coil booster pack, within the gradient coil assembly. The coil winding 26, 28, 30, 32 and 34 (FIG. 6) and 26, 28, 30, and 32 (FIG. 7) positions assigned for the main magnet in each Magnet Design by the minimization algorithm are shown in FIGS. 6 and 7 and can be seen numerically in TABLES 1-2. The values for the inner radius (ρ inner) and outer radius (ρ outer) as well as the values for the position along the length of the tunnel, the z-axis (z begin and z end) are shown. All measurements are indicated from a point of reference at the center of the magnet tube.

TABLE I
Coil Winding Positions for Magnet System Design 1 (Prior Art)

| | Magnet System Design 1 (FIG. 6) | | | | |
|---|---|---|---|---|---|
| | Winding | Winding | Winding | Winding | Winding |
| | #1 | #2 | #3 | #4 | #5 |
| | Reference No. | | | | |
| | 26 | 28 | 30 | 32 | 34 |
| ρ inner | 0.5001 m | 0.6276 m | 0.5008 m | 0.7202 m | 1.1894 m |
| ρ outer | 0.5231 m | 0.6536 m | 0.5708 m | 0.9102 m | 1.2464 m |
| z begin | 0.0314 m | 0.1307 m | 0.3278 m | 0.3161 m | 0.0017 m |
| z end | 0.0404 m | 0.1947 m | 0.3828 m | 0.4521 m | 0.1847 m |

TABLE II
Coil Winding Positions for Magnet System Design 2 (Invention)

| | Magnet System Design 2 (FIG. 7) | | | | |
|---|---|---|---|---|---|
| | | | Winding | | |
| | | | #3 | | |
| | Winding | Winding | Booster | Winding | Winding |
| | #1 | #2 | Pack | #4 | #5 |
| | Reference No. | | | | |
| | 26 | 28 | 36 | 30 | 32 |
| ρ begin | 0.5000 m | 0.6319 m | 0.3809 m | 0.7191 m | 1.2150 m |
| ρ end | 0.5310 m | 0.6519 m | 0.3939 m | 0.8781 m | 1.2620 m |
| z begin | 0.0262 m | 0.1483 m | 0.3049 m | 0.3631 m | 0.0134 m |
| z end | 0.0462 m | 0.1973 m | 0.3529 m | 0.4762 m | 0.1664 m |

After the coil winding positions of both magnets, and the coil booster pack position of Magnet Design #2 are decided, the Biot-Savart law is used to determine the magnetic field inside and outside the main magnet. This process is well known to one skilled in the art, and the lengthy description has been omitted from this example. The magnetic field calculations are used to determine the 5-Gauss line of the magnet. It is known within the art that the 5-Guass line is the line around the perimeter of the magnet and MR scanner outside of which the static magnetic fields are less than 5 gauss, which is considered the minimum safe level of static magnetic field exposure for non-MR safe (magnetic) objects and devices.

The residual magnetic field is then evaluated at two points on both Magnet Designs. Point 1 is at ρ=0.0 meters and z=4.5 meters (0.0, 4.5) from the magnet center and Point 2 was at ρ=4.6 meters and z=0.0 meters (4.6, 0.0) from the magnet center.

The moments within each Magnet System Design are also measured. The moments measured within the magnet design indicate the level of purity of the magnetic field produced by the main magnet. It is known from Prior Art that it is desired that the MR magnet design will have the smallest lower order moments possible, as low order moments define the inhomogeneity of the magnetic field. The larger the moment number, the higher the order, thus Z20 is a high order moment and Z2 is a low order moment. The total inhomogeneity of a superior magnet results from the contribution of higher order moments The moments calculated from Magnet Design #1 and Magnet Design #2 can be seen in TABLE III.

TABLE III
Results of additional magnet booster packs

| | |
|---|---|
| Magnet System | Magnet System |
| Design 1 | Design 2 |
| (w/out coil | (w/coil |
| booster packs) | booster packs) |

| Field Strength (Tesla) | | 1.50 | T | 1.51 | T |
|---|---|---|---|---|---|
| Homogeneity over | | 41.6 | ppm | 32.4 | ppm |
| the desired 45 cm × | | | | | |
| 35 cm FOV (ppm) | | | | | |
| Fringe | Point 1 | 9.59 | Gauss | 9.40 | Gauss |
| Field | (0.0, 4.5) | | | | |
| | Point 2 | 8.08 | Gauss | 7.56 | Gauss |
| | (4.6, 0.0) | | | | |
| Moments | Z 2 | 6.2942 | ppm | 2.6558 | ppm |
| (ppm) | Z 4 | 8.1260 | ppm | 5.4558 | ppm |
| | Z 6 | 0.5000 | ppm | 4.4208 | ppm |
| | Z 8 | −4.2538 | ppm | −1.0729 | ppm |
| | Z 10 | 0.0228 | ppm | −1.5600 | ppm |
| | Z 12 | 0.0524 | ppm | 0.2453 | ppm |
| | Z 14 | −0.0056 | ppm | −0.0090 | ppm |
| | Z 16 | 0.0003 | ppm | −0.0008 | ppm |

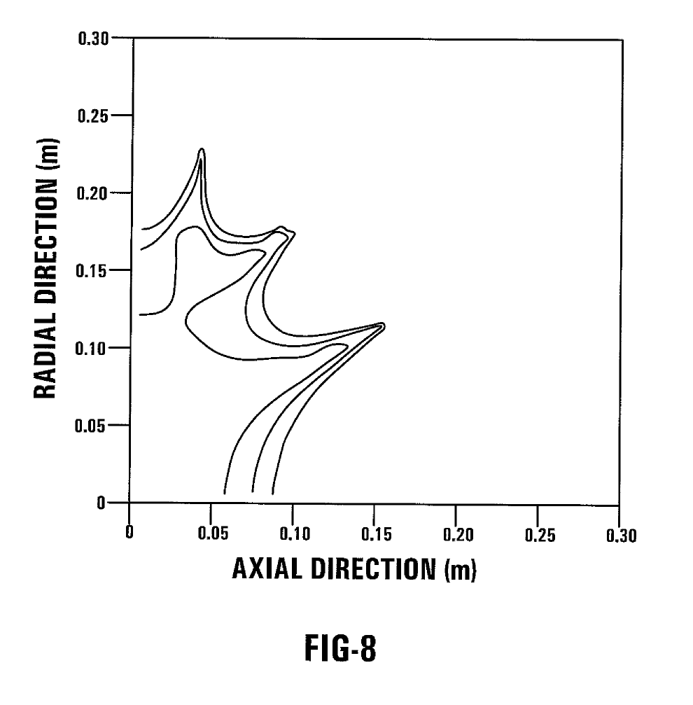

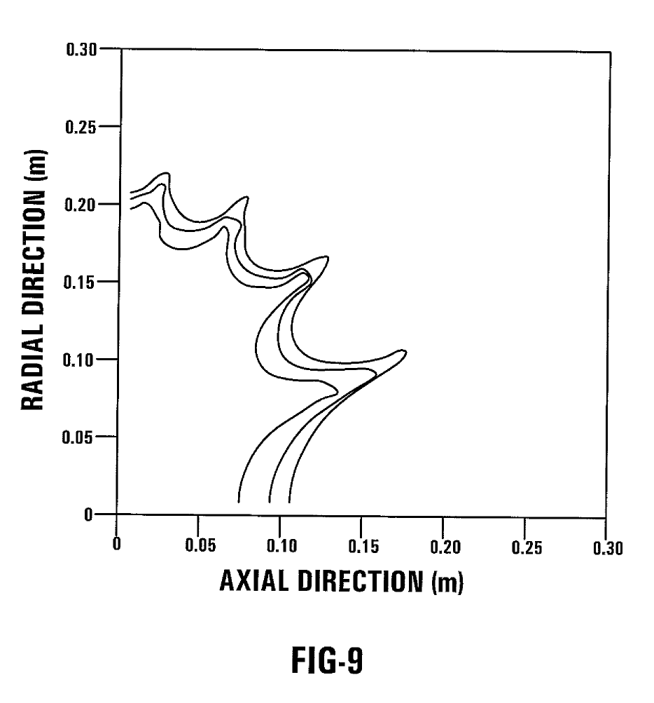

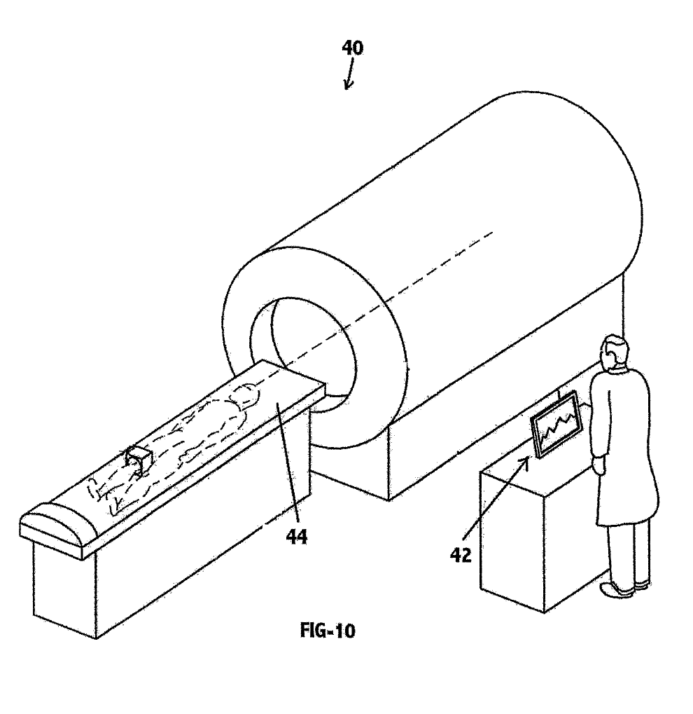

TABLE III along with FIGS. 8-9 show the benefits of adding the coil booster packs to the magnet design. The inhomogeneity of the magnet was decreased from 41.6 ppm to 32.4 ppm (almost 22%) by the addition of the booster packs. As with the Prior Art (Magnet System Design #1—FIG. 6), there are essentially no lower order moments created by the addition of the coil booster packs (Magnet System Design #2—FIG. 7), but the higher order moments of the magnet design were reduced by adding the coil booster packs. The addition of the coil booster packs not only effectively decreased the inhomogeneity of the magnet but also increased the usable imaging volume along the H-F direction.

The homogeneity pattern with respect to the radial direction ρ and the axial direction along the axis going through the tunnel z of Magnet System Design #1 (Prior Art without booster packs—FIG. 6) is illustrated by the contour plot shown in FIG. 8 and the homogeneity pattern with respect to the radial direction ρ and the axial direction along the axis going through the tunnel z of Magnet System Design #2 (with coil booster packs—FIG. 7) is illustrated by the contour plot shown in FIG. 9. One skilled in the art will recognize the homogeneity pattern of each magnet design from the contour plot representation. In general, ideal homogeneity is shown by a homogeneity contour plot by a closeness in proximity of the contour lines, and the absence of stray lines and marks outside of the main contour lines. As can be seen from FIG. 9, the homogeneity contour plot of Magnet Design #2 (with the coil booster pack—FIG. 7) shows less variation of distance between the main contour lines, and no stray contour lines or marks when compared with the homogeneity contour plot of Magnet Design #1 (Prior Art without booster packs—FIG. 6), as shown in FIG. 8. The homogeneity contour plot of Magnet Design #1 (Prior Art without booster packs—FIG. 6), shown in FIG. 8 has a broader distance span of main contour lines and possesses extraneous contour lines and marks away from the main contour lines. In other words, the main contour lines are tighter in proximity for the Magnet Design #2 with the coil booster pack 36 than for the Prior Art indicative Magnet Design #1 with no booster packs, indicating improved homogeneity.

Described herein is a magnet system for use in imaging a volume which includes a main magnet and at least one magnet coil assembly positioned between the main magnet and the imaging volume. A gradient coil assembly including at least one inner primary gradient coil alone or with the addition of an outer secondary gradient coil may also exist between the main magnet and imaging volume. The at least one magnet coil assembly may then be positioned between the at least one inner primary gradient coil and the imaging volume, between the at least one inner primary gradient coil and outer secondary gradient coil, or in both positions. Also described herein is an MRI system incorporating the magnet system with the additional at least one magnet coil assembly, and the process for improving the homogeneity of a magnet system using the at least one additional magnet coil assembly.

In the foregoing description, certain terms have been used for brevity, clearness, illustration and understanding; but no unnecessary limitations are to be implied therefrom beyond the requirements of the prior art, because such terms are used for descriptive purposes and are intended to be broadly construed. Moreover, this invention has been described in detail with reference to specific embodiments thereof, including the respective best modes for carrying out each embodiment. It shall be understood that these illustrations are by way of example and not by way of limitation.

1. A magnet system for use in imaging a volume which comprises:
a) a superconducting main magnet;
b) at least one gradient coil assembly located between said main magnet and said imaging volume; and
c) at least one superconducting magnet coil assembly positioned outside of the structure of said superconducting main magnet, between said superconducting main magnet and said imaging volume.

2. (canceled)

3. (canceled)

4. The magnet system of claim 1 wherein said at least one gradient coil assembly further comprises at least one inner primary gradient coil, and further wherein said at least one magnet coil assembly is positioned in a void in said gradient coil assembly between said primary gradient coil and said main magnet.

5. The magnet system of claim 4 wherein said at least one gradient coil assembly further comprises an outer secondary gradient coil, wherein said outer secondary gradient coil is located between said at least one magnet coil assembly and said main magnet.

6. The magnet system of claim 4 wherein said at least one gradient coil assembly further comprises an outer secondary gradient coil, wherein said outer secondary gradient coil is located between said at least one inner primary gradient coil and said at least one magnet coil assembly.

7. The magnet system of claim 1 wherein said at least one gradient coil assembly further comprises at least one inner primary gradient coil, and further wherein said at least one magnet coil assembly is positioned in a void in said gradient coil assembly between said at least one primary gradient coil and said imaging volume.

8. The magnet system of claim 7 wherein said at least one gradient coil assembly further comprises an outer secondary gradient coil, wherein said outer secondary gradient coil is located between said at least one inner primary gradient coil and said main magnet.

9. The magnet system of claim 1 wherein said at least one gradient coil assembly further comprises at least one inner primary gradient coil and an outer secondary gradient coil, and wherein at least one magnet coil assembly is positioned between said at least one inner primary gradient coil and said outer secondary gradient coil, and wherein a further at least one magnet coil assembly is positioned between said outer secondary gradient coil and said main magnet.

10. The magnet system of claim 1 wherein said at least one gradient coil assembly further comprises at least one inner primary gradient coil and an outer secondary gradient coil, and wherein at least one magnet coil assembly is positioned between said at least one inner primary gradient coil and said outer secondary gradient coil and wherein a further at least one magnet coil assembly is positioned between said at least one primary gradient coil and said imaging volume.

11. A magnet system for use in imaging a volume which comprises:
a) a superconducting main magnet;
b) at least one gradient coil assembly located between said main magnet and said imaging volume, said at least one gradient coil assembly further comprising
i.) at least one inner primary gradient coil and
ii.) an outer secondary gradient coil; and
c) at least one superconducting magnet coil assembly positioned in a magnet homogeneity enhancing location outside of the structure of said superconducting main magnet, said location selected from the group consisting of between said at least one inner primary gradient coil and said imaging volume, between said outer secondary gradient coil and said main magnet, and between said at least one inner primary gradient coil and said outer secondary gradient coil.

12. (canceled)

13. (canceled)

14. The magnet system of claim 11 wherein said enhancing location for at least one magnet coil assembly is between said at least one inner primary gradient coil and said imaging volume and wherein said enhancing location for a further at least one magnet coil assembly is between said at least one inner primary gradient coil and said outer secondary gradient coil.

15. The magnet system of claim 11 wherein said enhancing location for at least one magnet coil assembly is between said outer secondary gradient coil and said main magnet imaging volume and wherein said enhancing location for a further at least one magnet coil assembly is between said at least one inner primary gradient coil and said outer secondary gradient coil.

16. A process for improving the magnetic field homogeneity in an MRI magnet system comprising the step of adding at least one superconducting magnet coil assembly outside of the structure of the superconducting main magnet, wherein said at least one superconducting magnet coil assembly is positioned between said main magnet and said imaging volume.

17. A process for improving the magnetic field homogeneity in an MRI magnet system comprising:
a) adding at least one superconducting magnet coil assembly to said MRI magnet system, wherein said MRI magnet system comprises
i) a superconducting main magnet; and
ii) at least one gradient coil assembly located between said superconducting main magnet and said imaging volume, said at least one gradient coil assembly further comprising at least one inner primary gradient coil and an outer secondary gradient coil; and
b) positioning said at least one superconducting magnet coil assembly in a magnet homogeneity enhancing location outside of the structure of said main magnet, said location selected from the group consisting of between said at least one gradient coil assembly and said imaging volume, between said at least one gradient coil assembly and said superconducting main magnet and between said at least one inner Primary gradient coil and said outer secondary gradient coil.

18. (canceled)

19. (canceled)

20. The process of claim 17 wherein said enhancing location is between said inner primary gradient coil and said imaging volume.

21. The process of claim 17 wherein said enhancing location is between said at least one inner primary gradient coil and said outer secondary gradient coil.

22. The process of claim 17 wherein said enhancing location for at least one magnet coil assembly is between said at least one inner primary gradient coil and said imaging volume and wherein said enhancing location for a further at least one magnet coil assembly is between said inner primary gradient coil and said outer secondary gradient coil.

23. A magnetic imaging resonance system which comprises:
a) a superconducting main magnet for generating a main magnetic field through an examination region, the main magnet being arranged such that its geometry defines the examination region;
b) at least one gradient coil assembly for generating substantially linear magnetic gradients across the main magnetic field;
c) a couch which supports an imaging volume to be examined within the examination region;
d) a receiver which receives magnetic resonance signals from resonating dipoles within the examination region;
e) an image processor which reconstructs an image representation from the received magnetic resonance signals for display on a human readable display; and
f) at least one superconducting magnet coil assembly positioned outside of the structure of said main magnet, between said main magnet and said imaging volume.

24. The magnetic imaging resonance system of claim 23 wherein said at least one gradient coil assembly further comprises at least one inner primary gradient coil and an outer secondary gradient coil, and further wherein said at least one magnet coil assembly is positioned at a location selected from the group consisting of between said at least one inner primary gradient coil assembly and said imaging volume, between said outer secondary gradient coil and said main magnet, and between said at least one inner primary gradient coil assembly and said outer secondary gradient coil.

25. The magnetic imaging resonance system of claim 23 wherein said at least one gradient coil assembly further comprises at least one inner primary gradient coil and an outer secondary gradient coil, and further wherein said at least one magnet coil assembly is positioned between said at least one inner primary gradient coil and said outer secondary gradient coil, and at least one further magnet coil assembly is positioned at a location selected from the group consisting of between said at least one inner primary gradient coil and said imaging volume and between said outer secondary gradient coil and said main magnet.
